(19) United States
(12) Patent Application Publication
(10) Pub. No.: US 2005/0008541 A1
(43) Pub. Date: Jan. 13, 2005

(54) Method and device for locating and cutting out concentrations in a gel

(76) Inventors: Remo Anton Hochstrasser, Oberwil (CH); Hanno Langen, Steinen (DE)

Correspondence Address: HOFFMANN-LA ROCHE INC.;PATENT LAW DEPARTMENT, 340 KINGSLAND STREET, NUTLEY, NJ, 07110, US

(21) Appl. No.: 10/625,042

(22) Filed: Jul. 22, 2003

(30) Foreign Application Priority Data
Jul. 23, 2002 (EP) 02078009.4

(51) Int. Cl. G01N 21/00

(52) U.S. Cl. 422/82.05; 422/68.1

(57) ABSTRACT

The separate gel pieces from a gel cutting (27), it is necessary firstly to determine the position of the gel piece, e.g., by means of a scanner, and after an interval, which frequently lasts for some hours, to pick the gel pieces from the gel cutting (27). The gel cutting (27) must be stored in a gel holder (21) during this interval in an expansion-stable and positionally stable manner. For this purpose, the gel cutting (27) is held in the gel holder, floating in an equilibrating liquid (31). The equilibrating liquid causes the dimensions of the gel cutting to remain unchanged during the interval. With respect to the gel holder (21) the gel cutting (27) can be definitively positioned in that it is cut out so as to fit exactly in a chamber (24) of the gel holder (21), possibly being slightly larger than the chamber, and/or is held by a clamping device firmly in the edge region which is generally of no significance for the evaluation. Using this holding method the separation of gel pieces from the gel cutting (27) can be conveniently carried out by means of a tubular removal means which is pushed through the gel, since the gel cutting is not connected to the gel holder (21) over its surface but rather floats on a thin layer of equilibrating liquid (31).

### FIELD OF THE INVENTION

The invention relates to a method for positioning a gel in a gel holder such that a gel cutting is separated from the gel. It further relates to a device for carrying out the method and to a device for removing pieces of gel from a positioned gel.

### BACKGROUND OF THE INVENTION

In biotechnology in particular, mixtures of substances are often separated by exploiting of their different migration rates in gels, e.g., by chromatography or electrophoresis. The result of a separation of this type comes in the form of one or two dimensional distribution of concentration points of the substances in a gel layer. The concentration points are marked by suitable methods, e.g., colored for optical recognition. A currently used stain for this purpose is “Coomassie Blue”. After the positions of the concentration points in the gel have been determined the gel pieces, in which the concentration points lie, are removed from the gel and sent to further analysis or processing steps.

With the increasing need for methods of this type to be carried out, it is desirable to automate the implementation of these methods. Amongst other things, computerized methods for determining defined concentration points have been developed, as have robots for picking out the gel pieces. A method of this type and a device for use therein are known from WO-A-98/23950. In that case the gel is applied to a dimensionally stable carrier. In one example a glass plate is used for this purpose and has its surface functionalized by means of a bifunctional linker. When the gel is applied to the glass plate, covalent bonds form therefrom and attach the gel immovably to the glass surface. In a first step, the concentration points are marked by staining. Then depending on the user's requirement, the gel pieces to be cut out are electronically detected using a computer. The gel plate is then transferred to a picking robot (a so-called “gel picker”) which picks out gel pieces defined in the first step and transfers them to test vessels, e.g., the cavities (wells) in a micro titer plate. Because the gel is fixed to the carrier, a considerable amount of time occurs between the first step (the coloring) and the second step (the picking out), without noticeable deviations occurring in the positions of the gel pieces to be cut out and without detracting from the intended picking out of the gel pieces which contain the concentration points.

A disadvantage with this method, however, is the firm bonding of the gel to the carrier. For picking out a gel piece using a hollow needle-like instrument, it is thus necessary to penetrate right through the gel with the instrument until this instrument contacts the carrier and then to cut or shear the gel off the carrier by a lateral movement or other action. If the picking-out tool is then lifted, the underside of the gel is thus also directly exposed to the environment, which can lead to undesired reactions, e.g., oxidation, if no special, costly precautions are taken.

A disadvantage with the method in accordance with WO-A-98/23950 is also that when separating the gel from the carrier, parts of the connecting layer remain stuck to the gel and then behave like an impurity during the further analysis steps.

It is an object of the invention to provide a method for positioning a gel piece in a holder for a relatively long period, which method overcomes the above-mentioned disadvantages, wherein, however, the physical distribution of the concentration points should remain unchanged over a relatively long period.

### SUMMARY OF THE INVENTION

A method of this type is defined in the claims. The claims also define preferred embodiments, devices for carrying out the method, methods for separating out gel pieces from a gel layer positioned in accordance with the invention, and devices for this purpose.

In accordance with the invention, a gel cutting is placed in a holder and covered with an equilibrating liquid. The covering of the gel cutting with the equilibrating liquid makes it possible to achieve an equilibrium degree of swelling and thereby to ensure that the dimensions of the gel cutting and thereby the physical distribution of the concentration points remains unchanged over a relatively long period, e.g., for eight or more hours. This makes it possible to accurately remove gel pieces from measured concentration points in the gel cutting, although the whole method from measuring the position of the concentration points to removal of the gel pieces lying thereon takes a certain time and may take several hours.

Compared with the prior art described in the WO-A-98/23950, the methods and apparatuses according to the present invention offers the advantages with regard to the sequence of method steps required and a higher flexibility as to the marking method used (absorption, fluorescence, radioactivity, etc.). Moreover, an apparatus according to the invention allows removing gel pieces in a shorter time, because it only moves the gel piece removal means to preselected concentration points where gel pieces are to be removed, and does not require a detection step at each concentration point and a decision process carried out by suitable software for deciding whether or not a gel piece should be removed at a concentration point.

### DESCRIPTION OF THE FIGURES

Further advantages and properties of the methods and devices in accordance with the invention will be evident from the following description of exemplified embodiments which are explained with the aid of the accompanying drawings in which

FIG. 1 illustrates a plan view of a gel cutter 11;

FIG. 2 illustrates a cross-sectional view of the gel cutter 11 at the line A-A in FIG. 1.

FIG. 3 illustrates a plan view of a gel cutting 27;

FIG. 4 illustrates a cross-sectional view of the components of a gel holder 21;

FIG. 5 illustrates a cross-sectional view through the gel holder 21 according to FIG. 4 with a gel cutting 27 disposed therein;

FIG. 6 illustrates a cross-sectional view through the gel holder 21 in accordance with FIG. 4 with a smaller gel cutting than in FIG. 5;

FIG. 7 illustrates a perspective view of a picking robot 41;

FIG. 8 illustrates a perspective view of a picking tool 51; and

FIG. 9 illustrates an exploded view of the picking tool 51 in FIG. 8.

### REFERENCE NUMERALS IN DRAWINGS

11 gel cutter

12 base plate

13 raised portion

14 side wall

15 corners

16 blade strip

17 screws

18 cutting edge of gel cutter 11

21 gel holder

22 base plate

23 frame

24 chamber to receive the gel cutting

25 top frame/upper part of gel holder 21

26 limb/clamping part of the top frame 25

27 gel cutting

28 edge of the gel cutting

29 lower part

31 equilibrating liquid

41 picking robot

51 picking tool/removal device

53 carrier

55 cutting

57 curved region

58 curved region

61 bore

62 bore

63 end face

64 end face

65 liquid in picker 66

66 picker/removal means

68 helical spring

69 gel piece

71 setting ring

72 clamping screw

74 groove

76 toothed strip

77 carrier for the picking tool 51

78 transporter arm

79 an ejected gel piece

81 holes

82 upper end of the picker 66

83 lower end of the picker 66

91 micro titer plate

### DETAILED DESCRIPTION OF THE INVENTION

With a two dimensional polyacrylamide gel, a mixture of proteins, for example, is separated from a biological sample (e.g., serum, cell culture or tissue). By staining the separated samples, the proteins are made visible and their position in the gel layer is determined or detected by absorption, fluorescence, radio activity or luminescence on the gel. Depending on the method of coloring or marking, a corresponding reading device, e.g., a scanner, is used to determine or detect the position of the concentration points in digital form for further processing. The digital data are stored in a data bank and can be used by further programs, e.g., for the control of a picking robot. Programs of this type are commercially available.

It is crucial for the further processing of the gel that the positions of the marked concentration points in the gel layer remain unchanged over a relatively long period, e.g., for eight or more hours. To this end, the colored gel, which may possibly have been stored in a sealed manner for a relatively long period (e.g., bonded into a foil material), is preferably equilibrated in a liquid bath for several hours. In particular, time is allowed for an equilibrium degree of swelling to be achieved. The time required for this is established empirically.

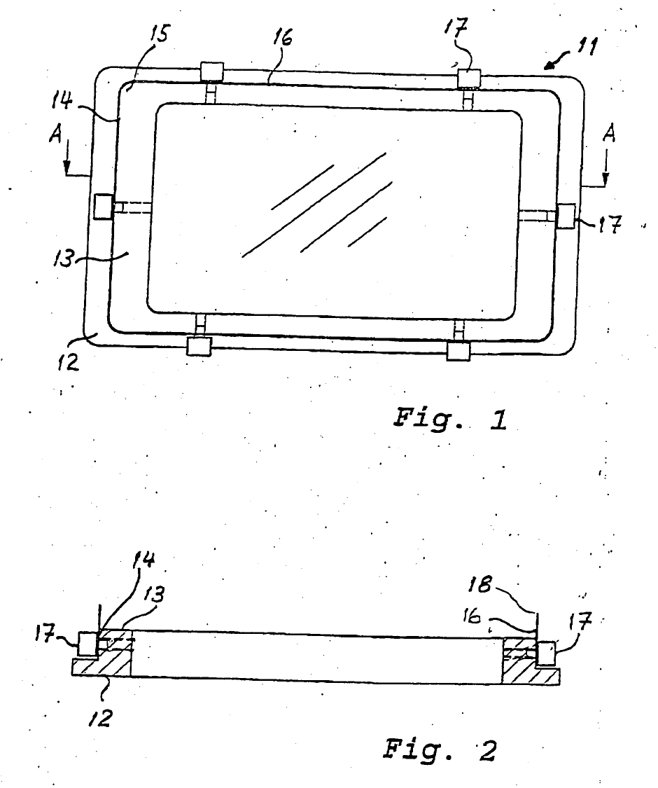

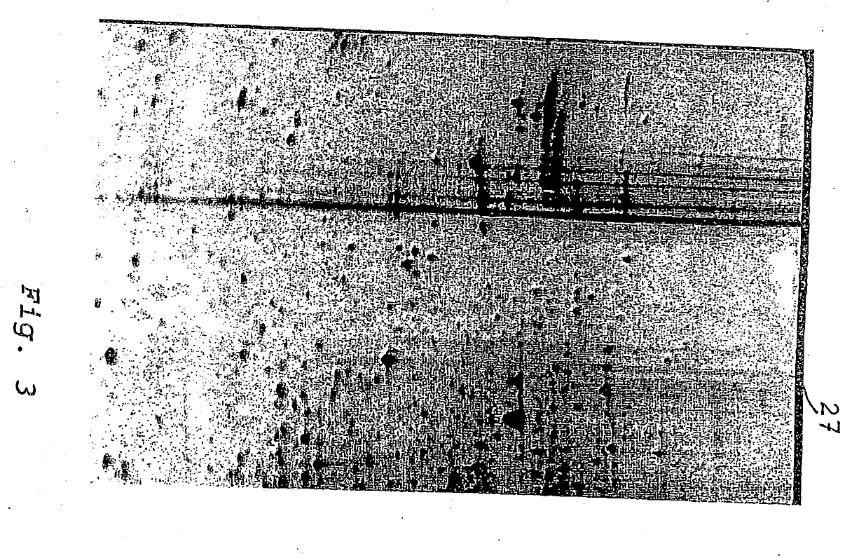

Then a gel cutting 27, illustrated in FIG. 3, is cut with a gel cutter 11 (described hereinunder with the aid of FIGS. 1 and 2) and placed in to the gel holder 21. A base plate 22 forms the bottom of the gel holder 21.

The base plate 22 is preferably transparent and the gel holder 21 is formed in such a way that it can be used with commercially available scanning devices, e.g., flat bed scanners. For this purpose, the gel can be stained with the stain “Coomassie Blue”.

Using a scanner, not shown, an image of an examined gel layer is taken, displayed on a screen and stored in the form of digital signals. Using a suitable program, concentration points, which stand out because of their coloring, are graphically marked on the image screen by a user and thus selected to be picked out. If appropriate, this selection can also be made automatically, e.g., in that all concentration points whose marking fulfills certain requirements (size, intensity) are marked for picking out.

The gel holder 21 is transferred into the picking robot 41. The picking robot approaches the selected concentration points and picks out the corresponding gel pieces 69 from the gel. They are then transferred into a storage container, not shown, e.g., micro titer plates with 96, 384 or 1536 cavities, which can be selected individually for placement of a gel piece 69.

### EXEMPLIFIED EMBODIMENT OF THE GEL CUTTER

FIGS. 1 and 2 show a gel cutter 11 in accordance with the invention.

The gel cutter 11 is constructed as follows: a base plate 12 has a raised portion 13 which forms rectangular side walls 14 with rounded corners 15. A metal blade strip 16 lies closely against the outer surface of the side walls 14 and is fixed with screws 17. The blade strip 16 has a cutting edge 18, the contour of which corresponds to a preset contour of a gel cutting 27 to be cut and separated.

The gel cutting 27 can but cut out by pushing the cutting edge 18 through the gel.

Gel cutting 27 has a thickness which is much smaller than the perimeter of the gel cutting 27. As described below, the perimeter of gel cutting is identical with or at least approximately equal to a predetermined perimeter of a chamber 24 for receiving the gel cutting in a gel holder 21.

The blade strip 16 can consist not only of metal but also of glass, ceramic or plastic material. A blade strip made of glass or ceramic consists, e.g., of a plurality of strip-like parts which are pushed one over another at the ends in order to lay these parts precisely against the outer wall 14. These parts are, for example, four strips bent at a right angle which are each laid against a corner of the raised portion 13 and of which the limbs overlap to some extent.

The blade strip 16 can also be formed as an integral component of the raised portion 13. In this case the screws 17 are omitted.

The blade strip 16 preferably has a sharp cutting edge 18 which allows a clean cut to be produced. However, it may be sufficient if the blade strip 17 is formed sufficiently thin.

Cutting edge 18 is preferably formed as a sharp edge of an strip 16 or an edging consisting of at least two strip-like elements, which is or are attached in a close fitting manner to the outer surface of raised portion 13, wherein the outer surface 14 of the raised portion defines the cutting line for the cutting edge 18.

The gel cutter 11 is placed on a gel with the cutting edge 18 downwards, and is pushed down. Thus, a gel cutting 27 predetermined by the form of the blade strip 16 is cut out of the gel and separated therefrom. The gel cutting 27 is then transferred into the gel holder 21 and is disposed therein as described below.

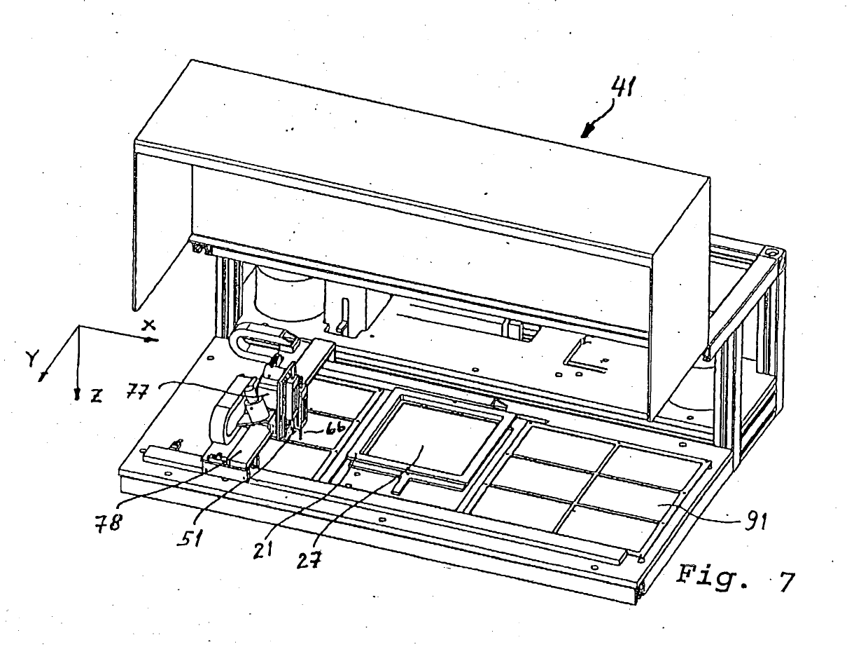

FIG. 7 shows a picking robot 14 in which a gel holder 21 is disposed.

### EXEMPLIFIED EMBODIMENT OF A GEL HOLDER

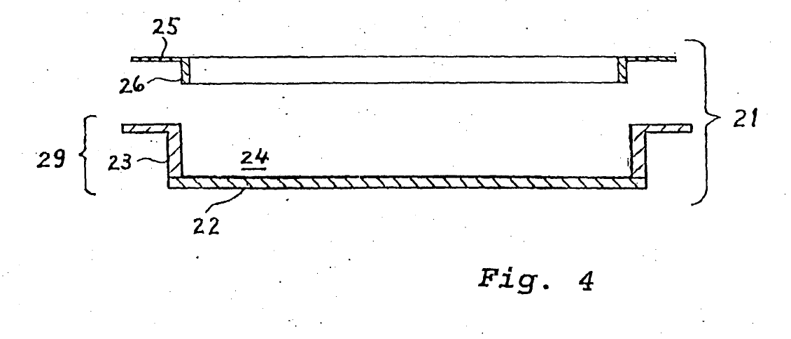

As shown by FIG. 4, the gel holder 21 consists substantially of a lower part 29 and an upper part 25.

The lower part 29 consists of a frame 23 to which a base plate 22 is attached. The upper surface of base plate 22 forms the bottom of lower part 29. The frame 23 and base plate 22 define a chamber 24 in the lower part 29. The chamber 24 has a bottom or base surface and is formed to receive a plate-like gel cutting.

The base plate 22 of the lower part 29 preferably consists at least in part of a material which is transparent to radiation, in particular light, which can be used for electro-optical scanning or detection of concentration points in a gel cutting 27 which is placed in the gel holder 21. If it is not necessary for the radiation to pass through from below, the gel plate 22 can also be formed to be impenetrable to light or energy or even to be reflective.

The upper part is a top frame 25 which has a clamping part 26 which protrudes into the chamber when the upper part 25 is placed on the lower part 29, so that a peripheral portion of a gel cutting 27 located in the chamber 24 can be clamped in between the clamping part 26 and the bottom surface of the chamber 24. The clamping part 26 is a strip which is formed so as to substantially complement the contour of the chamber 24 so that the clamping part 26 can be lowered into the chamber 24 by sliding against the side walls, which define the chamber 24, or with a small amount of clearance, so that the clamping effect of the clamping part 26 is established in a line at the edge 28 of a gel cutting 27 disposed in the lower part 29.

FIG. 4 shows a first embodiment in which the contour of the chamber 24 precisely matches the edge contour of the cutting edge 18 of the gel cutter 11. A gel cutting 27, which has been cut out of a gel layer by means of the gel cutter 11 thus fits into this chamber with a small amount of clearance.

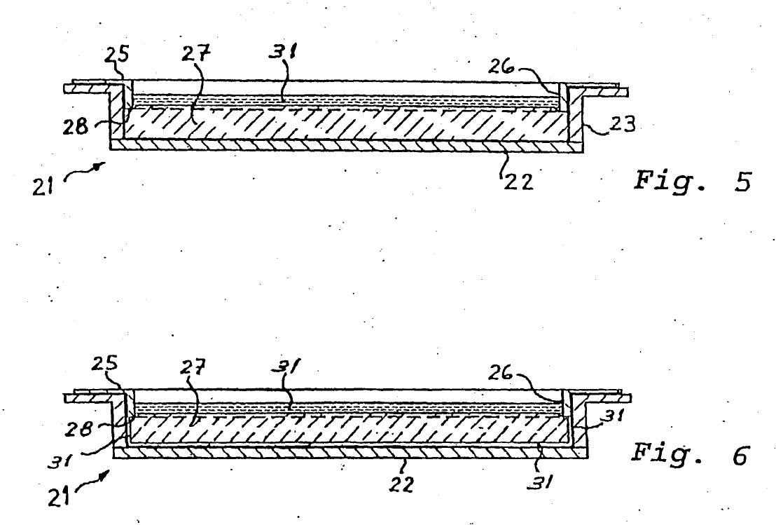

FIG. 5 shows a second embodiment in which the contour of the chamber 24 is slightly larger than the edge contour of the cutting edge 18. In this case, a gel cutting 27 is slightly smaller than the chamber 24 and can be disposed in the lower part 29 with a small amount of clearance.

In a third embodiment, not shown, the contour of the chamber can be slightly smaller than the edge contour of the cutting edge 18. In this case, the gel cutting 27 is slightly larger than the chamber 24 and can be disposed immovably in the lower part 29 without any clearance so that no further means are required to hold the gel cutting.

The top frame 25 is substantially an angled strip with a contour that is precisely adapted to the contour of the chamber in the lower part 29. The vertical limb 26 is of such a length that it lies on the edge of the gel and presses into this edge slightly when the top frame 25 is lying on the lower part 29. By means of the pressure thus exerted onto the edge 28 of the gel cutting 27, it is additionally held in the gel holder 21 in an immovable manner. This feature is particularly evident when the gel cutting is slightly smaller than the dimensions of the frame 23.

In the embodiment illustrated in FIG. 5, the gel cutting 27 is covered with a thin layer of equilibrating liquid 31.

In the embodiment illustrated in FIG. 6, the gel cutting 27 is also covered with a thin layer of equilibrating liquid 31 and a thin layer of the equilibrating liquid 31 also penetrates between the base plate 22 and the gel cutting 27, and between the frame 23 and the gel cutting 27 so that the gel cutting 27 is fully surrounded by equilibrating liquid 31. This feature ensures that the gel has a constant degree of swelling and therefore that its dimensions remain the same. For this purpose, however, it is necessary for the gel cutting 27 to lie in the equilibrating liquid for a sufficient length of time before scanning, so that this equilibrium degree of swelling can be achieved. In so doing, it is advantageous that an at least approximately constant temperature is maintained in the gel cutting 27 and equilibrating liquid 31.

### EXEMPLIFIED EMBODIMENT OF THE METHOD FOR POSITIONING A GEL CUTTING IN A GEL HOLDER

In accordance with the invention, a method for positioning a gel in a gel holder 21 includes the following steps:
(a) a gel cutting 27 is separated from the gel, the gel cutting having an edge contour which precisely or at least approximately corresponds to the contour of the chamber 24 for receiving the gel cutting 27 in the gel holder 21,
(b) the gel cutting 27 is inserted into the chamber 24 of gel holder 21, and
(c) the gel cutting 27 is covered with an equilibrating liquid 31.

In a first embodiment of the above-mentioned basic method, the edge contour of the gel cutting 27 precisely matches the contour of the chamber 24 so that when the gel cutting 27 is inserted into the chamber 24, it is disposed therein in a practically immovable manner.

By covering the gel cutting 27 with equilibrating liquid 31, the physical expansion and the position of the gel cutting in the chamber 24 over a relatively long period, e.g., eight or more hours, remains unchanged so that before storing the gel cutting in the gel holder 21, certain coordinates of selected concentration points remain valid and precise picking of gel pieces using these co-ordinates is assured even after a storage time, e.g., eight or more hours. In order to ensure that the position of the gel cutting 17 in the gel holder remains unchanged, the gel holder preferably contains additionally a clamping means 26 which lightly presses the edge region of the gel cutting 27 against the base plate of the gel holder 21.

In a second embodiment of the above-mentioned fundamental method, the edge contour of the gel cutting 27 is slightly larger than the contour of the chamber 24 so that when the gel cutting 27 is inserted into the chamber 24, it is immovably disposed therein. Since the gel cutting 27 is readily held in the chamber 24 in an immovable manner, additional means of fixing the position of the gel cutting 27 in the gel holder 21 (such as the use of the above-mentioned clamping means 26) are not necessary.

In a third embodiment of this method, the edge contour of the gel cutting 27 is slightly smaller than the contour of the chamber 24 so that when the gel cutting 27 is inserted into the chamber 24, it can move in the gel holder 21 by a smaller extent than a predetermined maximum permissible deviation between a picking position in the gel cutting 27 and the picking location in a picking device.

In this case, the gel cutting 27 is not only covered with equilibrating liquid 31 but is surrounded by this liquid, which improves the storability of the gel cutting 27 with unchanged physical expansion. The fact that the position of the gel cutting 27 in the gel holder also remains unchanged in this case is preferably assured by the use of the clamping means 26 which lightly presses the edge region of the gel cutting 27 against the base plate of the gel holder 21.

In the above described methods, the gel cutting 27 is separated from the gel by means of a gel cutter 11, wherein the gel cutter has a cutting edge with a contour that approximately corresponds to the contour of the chamber 24 for receiving the gel cutting 27 in the gel holder 21, wherein the term “approximately” means that it precisely corresponds or is slightly larger or slightly smaller.

In all of the examples of the method described above, the gel cutting 27 is cut by the gel cutter 11 being laid onto the gel. Gel cutting 27 is thereby separated from the gel.

In all of the examples of the method described above, the gel is preferably stored in the equilibrating liquid 31 before cutting of gel cutting 27.

In a preferred embodiment of the method, chamber 24 of gel holder 21, which contains the gel cutting 27, receives at least an amount of equilibrating liquid 31 which is sufficient for forming a layer of equilibrating liquid over the gel cutting 27, and this layer covers the whole surface of the gel cutting 27.

### EXEMPLIFIED EMBODIMENT FOR SCANNING AND SELECTION OF THE PICKING LOCATIONS

A gel holder 21 in accordance with the invention can be used in commercially available scanners, e.g., in flat bed scanners. If the gel holder 21 is formed in an appropriate manner, it can also be used in a specialized scanner, e.g., in the case of radioactive marking of the concentration points in the gel cutting.

For evaluation of the data provided by the scanner and for manual or automated selection of the concentration points to be picked out, systems which are already known in the art, such as the system described in WO-A-98/23950.

The image of the gel cutting produced by the scanner is basically illustrated on an image screen, also being shown in portions and greatly enlarged if required. An operator can use a cursor, which advantageously mimics the cutting geometry of the picking tool used, to approach the concentration points on the image screen, to mark them graphically and therefore to define and/or select the picking locations. As mentioned in WO-A-98/23950, a computer can determine concentration values and other characteristic data of the concentration points from the image information obtained with the scanner and can on this basis establish the picking points.

In order to ensure the advantages achieved with the method in accordance with the invention, after scanning, the gel holder 21 is stored with the gel cutting 27 for some time, e.g., for eight hours or more, preferably in a suitable enclosure and tempered, in order to avoid loss of equilibrating liquid 31. This is a means of preventing the expansion of the gel cutting 27 being changed over time and the positions of the concentration points being shifted relative to the gel holder 21.

As shown by FIG. 7, the gel holder 21 is placed in a picking robot 41 in order for the picking process to be carried out. The picking robot has a drive which can move a picking tool over the gel cutting 27 in the gel holder into desired positions. This drive can be controlled manually or preferably by a computer which stores the necessary control data or receives these control data from a control device.

### EXEMPLIFIED EMBODIMENT OF A REMOVAL DEVICE FOR REMOVING GEL PIECES FROM A GEL CUTTING

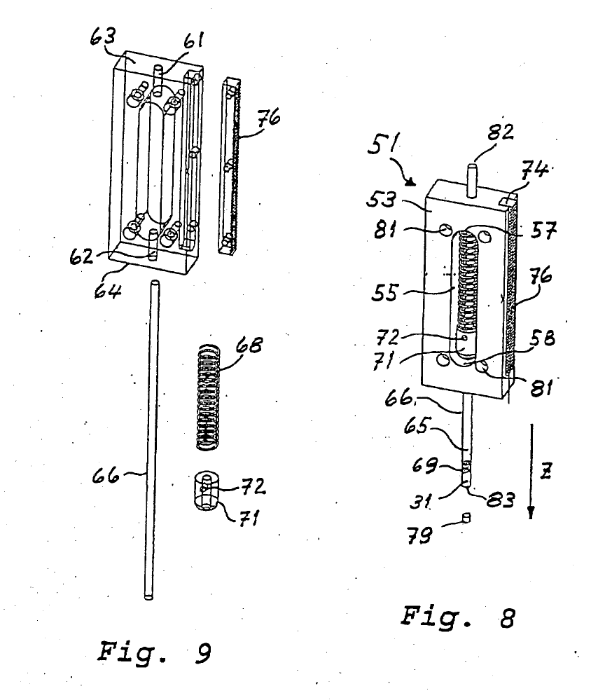

On the basis of a gel holder 21 in accordance with the invention and the associated manner of keeping the expansion of the gel cutting 27, and therefore the position of each point of the gel cutting, unchanged over a relatively long period, a novel picking tool 51 is advantageously used in accordance with the invention as the removal device to remove gel pieces from the gel cutting 27. A picking tool of this type is shown in FIGS. 8 and 9.

As shown in FIGS. 8 and 9 the picking tool 51 contains the following components:
(a) a substantially tubular removal means/picker 66 which is disposed in a longitudinally displaceable manner on a carrier 53 and has one of its ends 83, which serves to make the separation, formed as a picking means,
(b) a spring 68 which bears against the carrier 53 and the removal means/picker 66 so that the removal means/picker 66 can move out of its inoperative position against the return force of the spring 68.

In a preferred embodiment, the picking tool 51 is arranged in such a way that, when the removal means 66 is in the inoperative position, its end 83, which forms the picking means, protrudes furthest out of the carrier.

As FIGS. 8 and 9 show, a substantially oval elongate cutting 55 is located in a carrier 53. A bore 61 and 62 respectively issue from the upper and lower curved region 57, 58 to the upper and lower end face 63 and 64. The shape of the cutting 55 stems more from the use of a rotating milling cutter during production than from technical necessity. For example, the cutting can also have a rectangular cross-section.

The removal means is a picker 66 which is guided through the bores 61, 62 in a longitudinally displaceable manner in the vertical direction (Z-direction).

The picker 66 is a tube, the upper end of which is connected to an underpressure/overpressure arrangement which contains liquid under negative pressure or positive pressure. It is therefore possible to produce underpressure in the picker 66 in order to draw material in its lower end. Conversely, by blowing in air or another gas, it is possible to eject material which has been drawn in back out of the picker 66 in the downwards direction. In order to prevent this material rising into the underpressure/overpressure arrangement a through-flow limiter, which is known in the art, is provided in the picker 66 or in the underpressure/overpressure arrangement (not shown).

Within the cutting 55, a helical spring 68 surrounds the picker 66. The helical spring 68 bears on the one hand against the upper curved region 57 of cutting 55 and on the other against a setting ring 71. The setting ring 71 is attached to the picker in a suitable manner, e.g., by a clamping screw 72.

The helical spring 68 is dimensioned in such a way that, when the setting ring 71 is in the inoperative position, it presses lightly against the lower curved region 58 of the cutting 55.

In one long side of the carrier 53 is a groove 74, parallel to the picker 66. A toothed strip 76 is inserted into this groove.

The picking tool 51 is suitably attached to a movable transporter arm 78 (FIG. 7) of an X-Y-Z transporter device in such a way that the picking tool 51 can move in the vertical direction in order to lower the picker 66 through the gel cutting 27 in the gel holder 21 and to be able to raise it again. The structure and function of an X-Y-Z transporter device are known in the art and not described in more detail here.

In the exemplified embodiment, the movement of the picking tool 51 in the vertical direction is effected by a toothed wheel, not shown, engaging into the toothing of the toothed strip 76 so that rotation of the toothed wheel in one direction or the other raises or lowers the picking tool 51. The picking tool 51 can be attached, e.g., by means of screws, which are inserted through holes 81, to a vertically moveable carriage or the like. The movement of the picking tool 51 can also be achieved by the carrier 53 being laterally guided in rails or by attachment of the picking tool 51 on a carriage which is connected to a drive. The picking tool 51 can also be moved in the vertical direction by means of a pneumatic drive.

In a further embodiment, a plurality of parallel-operating picking tools 51 are used at the same time.

In order to carry out the picking operation, the picking tool 51 is moved by the picking robot 41 by movement of the arm 78 in the X direction and of the carrier 77 of the picking tool 51 on the arm 78 in the Y direction to a predetermined picking position.

The picking tool 51 is lowered in the Z direction. In so doing, the lower end of the picker 66 first contacts a layer of equilibrating liquid. As the lowering movement continues, it is advantageously ensured that a short column of equilibrating liquid 31 enters the picker 66. For this purpose, there must either be an equalization of pressure with respect to the environment, or slight underpressure can even be applied to the picker 66 by detecting contact of the picker with the surface of the equilibrating liquid 31 or by passing below a certain level.

If the picker 66 is a hollow needle which is made of metal and is therefore electrically conductive, then contact of the picker with the equilibrating liquid 31 is detected, for example, by establishing the occurrence of an electrical contact between the picker 66 and the equilibrating liquid 31 by means of an electronic circuit.

As the lowering movement continues, the lower end 83 of the picker 66 finally penetrates the gel cutting 27, wherein a gel piece 69 is pushed into the picker 66. Finally, the lower end 83 contacts the base plate 22. Since the picker can move in the carrier 53 in the longitudinal direction, it is not necessary to stop the movement of the picking tool 51 in the Z direction at the moment of contact with the base plate 22. This is advantageous because it is unnecessary to detect the picker 66 contacting a fixed obstacle (the base plate 22), or to consider the difference in resistance when penetrating the gel cutting 27 and the resistance when contacting the base plate 22.

In contrast, it is conveniently possible to move the picking tool 51 downwards until the setting ring 71 is pushed back by a certain amount against the force of the spring 68. The movement is then stopped since the picking tool then arrives safely on the base plate 22. In contrast to the prior art, in particular in the case of the solution in which the gel is fixedly connected to a dimensionally stable carrier, in accordance with the present invention a gel piece is therefore already fully separated from the gel cutting 27. Underpressure is applied to the picker 66 in order to draw a small amount of additional equilibrating liquid 31 into the picker 66. As a result, a gel piece is then located in the picker 66 and is separated from the environment in both the upwards and downwards direction by means of a short column of equilibrating liquid, i.e., it is always surrounded by equilibrating liquid.

### EXEMPLIFIED EMBODIMENT OF A PICKING ROBOT

The picking robot 41 drives the picking tool 51 over the storage vessels, e.g., over the cavities (wells) of a micro titer plate 91 (see FIG. 7), positions it over one of the vessels and ejects the content of the picker 66 downwards by application of overpressure into a storage vessel. In this way the picking tool is rinsed by the equilibrating liquid 31 so that a special rinsing process or the use of a picker with a disposal picking insert is unnecessary.

Since with this method in each case a certain quantity of equilibrating liquid 31 is removed from the gel holder, the gel holder 21 is sufficiently replenished with equilibrating liquid 31 in accordance with the invention in order to ensure that the gel cutting remains surrounded by a sufficient quantity of equilibrating liquid.

A further advantage of the invention is found in that no ambient air is drawn into the picker 66 and therefore not transferred into one of the vessels in the micro titer plates 91.

### EXEMPLIFIED EMBODIMENT OF A METHOD FOR REMOVING GEL PIECES FROM A GEL CUTTING

In accordance with the invention, one method for separating and removing gel pieces from a gel cutting 27, which is located together with an equilibrating liquid 31 in a gel holder 21, comprises the following steps:
(a) the gel cutting 27 is disposed and held in a gel holder 21 in such a way that both above and below the gel cutting 27 at least in the region of the pieces to be removed a layer of equilibrating liquid 31 is located,
(b) a tubular removal means/picker 66 is pushed through the gel cutting 27 with its end 83 comprising an opening, and then by production of underpressure in the removal means/picker 66, a picked-out gel piece 69 and equilibrating liquid 31 which follows it are drawn into the removal means/picker 66 so that the gel piece 69 is separated from the opening 83 of the removal means/picker 66 by means of a column of the equilibrating liquid 31.

In the method in accordance with the invention, the gel cutting 27 is preferably disposed in the gel holder 21 in such a way that it floats in the equilibrating liquid 31 and is spaced apart from the bottom of the gel holder 21. In order to separate a gel piece 69 from the gel cutting, it will therefore suffice to insert a picking tool 51. Since equilibrating liquid 31 is also provided below, the gel cutting 27, when picking out from the gel cutting by application of underpressure in the picker 66, some equilibrating liquid 31 is first drawn in, then a gel piece 69 is picked out and then some more equilibrating liquid 31 is drawn after it.

The column of equilibrating liquid 31 drawn in after the piece constitutes a separation of the received gel piece 69 from the environment. Above a cut-out gel piece 69 a small column of equilibrating liquid 31 is also located so that the gel piece 69 is also shielded from the environment in this direction.

Within the framework of the method just described, a layer of the equilibrating liquid 31 is preferably maintained above the gel cutting 27 so that when the removal means/picker 66 penetrates the gel cutting 27, a short column of the equilibrating liquid 31 is first received in the removal means/picker 66 so that after separation of a gel piece 69, a layer of the equilibrating liquid 31 is also provided above the gel piece 69 in the removal means/picker 66.

Preferably before separation of the gel pieces 69 from gel cutting 27, the locations in the gel cutting 27 where the gel pieces to be separated lie are determined, the gel holder 21 is inserted into a removal apparatus with at least one removal device 51 with a removal means/picker 66, and the removal device 51 is positioned at the predetermined locations on the gel cutting 27 and removal of the gel pieces 69 is carried out.

A separated gel piece 69 is ejected from the removal means/picker 66 preferably by production of overpressure in the removal means/picker 66.

Within the framework of the method described above for separating and removing gel pieces 69 from a gel cutting 27, a gel holder 21 is preferably used which has a lower part 29 and an upper part 25, wherein the lower part has a chamber 24 which has a bottom surface and is formed to receive a plate-like gel cutting 27, and the upper part 25 has a clamping part 26 which, when the upper part 25 is placed on the lower part 29, protrudes into the chamber so that peripheral area of a gel cutting 27 located in the chamber 24 can be clamped in between the clamping part 26 and the bottom surface of the chamber 24.

### EXEMPLIFIED EMBODIMENT OF A DEVICE FOR ANALYZING PREDETERMINED AREAS OF GEL CUTTING

A device for analyzing predetermined areas of a gel cutting, in particular of concentration points after a mixture separation has been carried out in the gel, includes the following components:
(a) a first device in which a gel holder 21 can be inserted and which has means for detecting the areas of the gel cutting 27, which are to be analyzed and/or for producing a representation of the gel cutting in which areas involved in the analysis can be recognized, which analysis device contains means for marking the areas to be analyzed on an electronically produced image of the gel cutting, the gel cutting (27) being in contact with an equilibrating liquid (31) in the gel holder (21), and
(b) a second device comprising a receiving point for the gel holder 21 and transport means to position a removal device 51, which serves to separate and remove a piece 69 from a gel cutting 27, over the selected areas of the gel cutting in the gel holder 21 which are to be analyzed, and to move it towards the gel cutting 27 so that the removal means/picker 66 can be driven through the gel cutting 27 at a respective predetermined location for picking up a gel piece 69.

In a preferred embodiment gel, cutting 27 is embedded in equilibrating liquid 31 contained in chamber 24 of gel holder 21. Means for establishing contact between gel cutting 27 and equilibrating liquid 31 are described above in the description of gel holder 21.

In a preferred embodiment, the removal apparatus 51 is connected to a device for producing underpressure and overpressure in the removal means/picker 66 so that by means of underpressure in the removal means/picker 66, a gel piece 69 separated by the removal means/picker can be drawn into the removal means/picker and a further quantity of the liquid 31 which surrounds the gel piece can be drawn in after the gel piece, and by production of overpressure in the removal means/picker 66 the material received by the removal means/picker, in particular the gel piece 69, can be ejected out of the removal means/picker 66.

In a preferred embodiment the gel holder 21 includes a lower part 29 and an upper part 25, wherein the lower part has a chamber 24 which has a bottom surface and is formed to receive a plate-like gel cutting, and the upper part 25 has a clamping part 26 which, when the upper part 25 is placed on the lower part 29, protrudes into the chamber so that a gel cutting 27 located in the chamber 24 can be clamped in between the clamping part 26 and the bottom surface of the chamber 24.

In a preferred embodiment the removal device 51 contains the following components:
(a) a substantially tubular removal means/picker 66 which is disposed in a longitudinally moveable manner on a carrier 53 and of which one end 83, serving to make the separation, is formed as a picking means, and
(b) a spring 68, which bears against the carrier 53 and the removal means/picker 66, so that the removal means/picker 66 can be moved out of its inoperative position against the return force of the spring 68.

The description above will allow the person skilled in the art to make a number of modifications to the devices and methods in accordance with the invention without departing from the field of protection of the invention as defined in the claims.

1. A method for positioning a gel in a gel holder comprising:
(a) separating a gel cutting (27) from the gel, said gel cutting having an edge contour which corresponds to the contour of the chamber (24) for receiving the gel cutting (27) in a gel holder (21),
(b) inserting the gel cutting (27) into said chamber (24) of said gel holder (21), and
(c) covering the gel cutting (27) with an equilibrating liquid (31).

2. The method according to claim 1, wherein the edge contour of the gel cutting (27) is smaller than the contour of the chamber (24) so that when the gel cutting (27) is inserted into the chamber (24) the gel cutting can move in the gel holder (21) by an extent which is smaller than a predetermined maximum permissible deviation between a picking position in the gel cutting (27) and the picking location in a picking device.

3. The method according to claim 1, wherein the edge contour of the gel cutting (27) is larger than the contour of the chamber (24) so that when the gel cutting (27) is inserted into the chamber (24) the gel cutting is immovably disposed therein.

4. The method according to claim 1, wherein the position of the gel cutting (27) is fixed with respect to the chamber (24) by a clamping means (25).

5. The method according to claim 1, wherein the gel cutting (27) is separated from the gel by means of a gel cutter (11), wherein the gel cutter (11) has a cutting edge (18) with a contour which approximately corresponds to the contour of the chamber (24) for receiving the gel cutting (27) in the gel holder (21).

6. The method as claimed in claim 5, comprising carrying out the cutting and thereby the separation of the gel cutting (27) from the gel by placing the gel cutter (11) onto the gel.

7. The method according to claim 1, wherein the gel is stored in the equilibrating liquid (31) before cutting said gel cutting (27).

8. The method according to claim 1, wherein said chamber (24) of said gel holder (21), which contains the gel cutting (27), receives at least an amount of equilibrating liquid (31) which is sufficient for forming a layer of equilibrating liquid over the gel cutting (27), said layer covering the entire surface of the gel cutting (27).

9. A gel holder for carrying out a method according to claim 1, which comprises a lower part (29) and a frame-like upper part (25), wherein the lower part has a chamber (24) that has a bottom surface and is formed to receive a plate-like gel cutting, and the upper part (25) has a clamping part (26) which, when the upper part (25) is placed on the lower part (29), protrudes into the chamber so that a peripheral portion of a gel cutting (27) located in the chamber (24) can be clamped in between the clamping part (26) and the bottom surface of the chamber (24).

10. A gel holder according to claim 9, wherein the lower part (29) has a bottom consisting of at least in part of a material that is transparent to radiation, in particular light, that can be used to detect concentration points in a gel cutting (27).

11. A gel holder according to claim 9, wherein the clamping part (26) is a strip that substantially complements the contour of the chamber (24) so that the clamping part (26) can be lowered into the chamber (24) by sliding against the side walls, which define the chamber (24), or with a small amount of clearance, so that the clamping effect of the clamping part (26) is established in a line at the edge (28) of a gel cutting (27) disposed in the lower part (29).

12. A gel cutter for carrying out a method according to claim 1, which comprises a cutting edge (18), having a contour that corresponds to a predetermined contour of a gel cutting (27) to be cut, so that the gel cutting (27) can be cut out by the cutting edge being pushed through the gel, said gel cutting (27) having a thickness which is smaller than the perimeter of the gel cutting (27) and said perimeter is identical with or at least approximately equal to the perimeter of a chamber for receiving the gel cutting in a gel holder.

13. A gel cutter according to claim 12, wherein the cutting edge (18) is formed as a sharp edge of strip (16) or an edging consisting of at least two strip-like elements, which is or are attached in a close fitting manner to the outer surface of a raised portion (13), wherein the outer surface (14) of the raised portion defines the cutting line for the cutting edge (18).

14. A gel cutter according to claim 13, wherein the strip (16) or strip-like elements comprises of metal, ceramic, glass or plastic material.

15. A method for separating and removing gel pieces from a gel cutting (27) that which compound is located in a gel holder (21) together with an equilibrating liquid (31), which comprises
(a) locating a layer of equilibrating liquid (31) both above and below the gel cutting (27) at least in the region of the gel cutting where the pieces thereof are to be removed,
(b) pushing a tubular removal means (66) through the gel cutting (27) with the end of this tubular removal means (83) comprising an opening, and then by production of underpressure in the removal means (66) a picked-out gel piece (69) and equilibrating liquid (31) that follows the end of the tubular removal means are drawn into the removal means (66) so that the gel piece (69) is separated from the opening at said end (83) of the removal means (66) by means of a column of the equilibrating liquid (31).

16. The method according to claim 15, which comprises maintaining a layer of the equilibrating liquid (31) above the gel cutting (27) so that when the removal means (66) penetrates the gel cutting (27), a short liquid column of the equilibrating liquid (31) is first received in the removal means (66) so that after separation of a gel piece (69), a layer of the equilibrating liquid (31) is also provided above the gel piece (69) in the removal means (66).

17. The method according to claim 15, which comprises inserting the gel holder (21) into a removal apparatus that comprises at least one removal device (51) having a removal means (66), and positioning the removal device (51) at the predetermined locations on the gel cutting (27) and removing the gel pieces (69) by means of the removal device (51) prior to separating the gel pieces (69).

18. The method according to claim 15, which comprises ejecting a separated gel piece (69) from the removal means (66) by production of overpressure in the removal means (66).

19. The method according to claim 15, wherein a gel holder (21) is used that has a lower part (29) and an upper part (25), wherein the lower part has a chamber (24) which has a bottom surface and is formed to receive a plate-like gel cutting (27), and the upper part (25) has a clamping part (26) which, when the upper part (25) is placed on the lower part (29), protrudes into the chamber so that a peripheral portion of a gel cutting (27) located in the chamber (24) can be clamped in between the clamping part (26) and the bottom surface of the chamber (24).

20. A removal device for separating and removing a gel piece (69) from a gel cutting (27) when carrying out a method in accordance with claim 15, wherein the device comprises:
(a) a substantially tubular removal means (66) disposed in a longitudinal displaceable manner on a carrier (53) and has one of its ends (83), that serves to make the separation, formed as a picking means, and
(b) a spring (68) that bears against the carrier (53) and the removal means (66) so that the removal means (66) can move out of its inoperative position against the return force of the spring (68).

21. The removal device according to claim 20, wherein when the removal means (66) is in the inoperative position, its end (83), which forms the picking means, protrudes furthest from the carrier (53).

22. A device for analyzing predetermined areas of a gel cutting, which comprises in particular of concentration points after a mixture separation has been carried out in the gel, said device comprises:
(a) a first device in which a gel holder (21) for receiving a gel cutting (27) can be inserted and which has means for detecting areas of the gel cutting (27) to be analyzed or for producing a representation of the gel cutting (27) in which areas involved in the analysis can be recognized, and
(b) a second device comprising a receiving point for the gel holder (21) and transport means for positioning a removal device (51), which serves for separating and removing a gel piece (69) from a gel cutting (27), over the selected areas of the gel cutting (27) in the gel holder (21) which are to be analyzed, and to move it towards the gel cutting (27) so that removal means (66) can be driven through the gel cutting (27) at a respective predetermined location for picking up a gel piece (69).

23. The device of claim 22 wherein the first device contains means for marking the areas to be analyzed on an electronically produced image of the gel cutting (27), said gel cutting (27) being in contact with an equilibrating liquid (31) in said gel holder (21),

24. The device according to claim 22, wherein the removal means (66) is connected to a device for producing underpressure and overpressure in the removal means (66) so that by means of underpressure in the removal means, (66) a gel piece (69) separated by the removal means (66) can be drawn into the removal means and a quantity of the liquid (31), surrounding the gel pieces, can be drawn in after the gel piece, and by production of overpressure in the removal means (66) the material received by the removal means, in particular the gel piece (69), can be ejected out of the removal means (66).

25. The device according to claim 22, wherein the gel holder (21) has a lower part (29) and an upper part (25), wherein the lower part has a chamber (24) which has a bottom surface and is formed to receive a plate-like gel cutting, and the upper part (25) has a clamping part (26) which, when the upper part (25) is placed on the lower part (29), protrudes into the chamber so that a peripheral portion of a gel cutting (27) located in the chamber (24) can be clamped in between the clamping part (26) and the bottom surface of the chamber (24).

26. The device according to claim 22, wherein the removal device (51) comprises:
(a) a substantially tubular removal means (66) which is disposed in a longitudinally moveable manner on a carrier (53) and of which one end (83), serving to make the separation, is formed as a picking means, and
(b) a spring (68), which bears against the carrier (53) and the removal means (66), so that the removal means (66) can be moved out of its inoperative position against the return force of the spring (68).
